(19) United States
(12) Patent Application Publication
(10) Pub. No.: US 2015/0376798 A1
(43) Pub. Date: Dec. 31, 2015

(54) High aspect ratio dense pattern-programmable nanostructures utilizing metal assisted chemical etching

(71) Applicant: The Board of Trustees of the Leland Stanford Junior University, Palo Alto, CA (US)

(72) Inventors: Anne Eugenie Sakdinawat, Menlo Park, CA (US); Chieh Chang, San Jose, CA (US)

(21) Appl. No.: 14/760,305

(22) PCT Filed: Mar. 14, 2014
(86) PCT No.: PCT/US2014/027338

§ 371 Date: Jul. 10, 2015

Related U.S. Application Data
(60) Provisional application No. 61/782,692, filed on Mar. 14, 2013.

(51) Int. Cl. C23F 1/02; G21K 1/06; G02B 5/18

(52) U.S. Cl. CPC C23F 1/02; G02B 5/1838; G21K 1/06; G21K 2201/067

(57) ABSTRACT

A method of ultra-high aspect ratio high resolution vertical directionality controlled metal-assisted chemical etching, V-MACE, is provided that includes forming a pattern on a substrate surface, using a lithographic or non-lithographic process, forming hole concentration balancing structures on the substrate, using a lithographic process or non-lithographic process, where the concentration balancing structures are proximal to the pattern, forming mechanical anchors internal or external to the patterned structures, forming pathways for etchant and byproducts to diffuse, and etching vertical features from the substrate surface into the substrate, using metal-assisted chemical etching, MACE, where the vertical features are confined to a vertical direction by the concentration balancing structures.

### FIELD OF THE INVENTION

The present invention relates generally to patterned nanostructures. More particularly, the invention relates to a method of creating high aspect ratio patterned nanostructures while controlling the directionality, including constraining the directionality to the vertical direction, of the etch through utilization of hole concentration balancing structures, mechanical anchors internal or external to the patterned nanostructures, pathways for etchant and byproduct diffusion either by dimension of the patterned nanostructure or by porosity of the metal catalyst, and optimal etch temperatures and etchant concentrations.

### BACKGROUND OF THE INVENTION

High aspect ratio nanostructures play a major role in many scientific and technological fields, including but not limited to computer chips, computer memory, computer devices, nanostructured materials, thermoelectric materials, sensors, battery materials, chip-based electron accelerators, diffractive optics, and other devices.

One example of an application for high aspect ratio nanostructures is in the area of x-ray diffractive optics. Diffractive optics have played a major role in nanoscale x-ray imaging and focusing in the soft x-ray region. X-ray microscopes capable of mapping material properties, performing tomography, and probing various types of samples from computer chips to biological cells in the tens of nanometers resolution have become a powerful scientific tool. However, in the hard x-ray region where penetration lengths are much greater and thicker samples can be studied, it is more difficult to control the wavefront of x-rays with both high efficiency and high resolution due to the difficulty in fabricating ultra-high aspect ratio diffractive optics.

High resolution, high efficiency x-ray diffractive optics, such as zone plates are challenging to fabricate due to the need to make dense, very high aspect ratio, nanoscale structures to maintain both high spatial resolution and high diffraction efficiency. The smallest features, located at the outermost zones of the zone plate, define the numerical aperture of the lens at a given wavelength. The thickness of the zones for a given wavelength and material, is related to the diffraction efficiency. Higher x-ray energies require thicker zones for efficient focusing, and therefore, require zone plates with ultra-high aspect ratio nanostructures. For extremely high aspect ratio and high resolutions typically less than 10 nm, volume effects occur, and to gain efficiency, zones must be tilted/tapered.

Current methods used to produce x-ray diffractive optics include top-down methods involving patterning of a thick resist mold, pattern transfer into a substrate using deep reactive ion etching, anisotropic Si wet etch, multiple patterning techniques, multilayer Laue lens, various multilayer-sliced zone plate techniques, lithographic stacking, and mechanical stacking. Advantages and tradeoffs exist with each method. For example, traditional top-down diffractive optics fabrication methods commonly result in aspect ratios of 12:1 or less, but are relatively simple to produce. Mechanical stacking is currently the most utilized technique for producing high aspect ratio x-ray diffractive optics. Though possible, challenges exist for stacking more than two zone plates. Multilayer Laue lenses can achieve very high aspect ratio but are limited to linear structures and small effective areas. Focusing in two dimensions requires a pair of lenses and a reduction in efficiency proportional to the number of lenses used. Multilayer-sliced zone plate techniques such as the method using atomic layer deposition and focused ion beam can produce very high aspect ratio structures with very small feature sizes but are limited to circular structures, small effective areas, and errors in zone shapes.

Metal-assisted chemical etching (MACE) using noble metals is a simple and low-cost method used to fabricate Si nanowires, nanoporous silicon, and nanopillars. In MACE, a noble metal layer, such as Au is patterned onto the substrate. This serves as the etch mask. An etchant solution including hydrogen peroxide (H₂O₂), hydrofluoric acid (HF), and water (H₂O) is placed onto the pattern and substrate, and Si is etched, creating trenches in the substrate. Movement of the metal catalyst during the etching process, such as sliding, rotation, and folding has been shown to create interesting 3D patterns. However, due to this movement, the aspect ratio achievable for vertical features in an isolated, arbitrary pattern has been limited.

What is needed in the art is a method to fabricate high efficiency hard x-ray diffractive optics using vertical directionality controlled metal assisted chemical etching. Such a process would open up new opportunities for high-resolution microscopy with compact x-ray microscopes, and for more sophisticated wavefront-manipulating capabilities for synchrotrons and x-ray free electron lasers. This is one of many applications that exist for high aspect ratio nanostructures.

### SUMMARY OF THE INVENTION

To address the needs in the art, a method of ultra-high aspect ratio high resolution vertical directionality controlled metal-assisted chemical etching, V-MACE, is provided that includes forming a metal pattern on a substrate surface, forming concentration balancing structures onto the substrate, where the concentration balancing structures are proximal to the pattern, etching directionality controlled features from the substrate surface into the substrate, using metal-assisted chemical etching, MACE, where the direction of the features are controlled by the concentration balancing structures.

In one aspect the invention further includes forming metal anchors external or internal to the metal patterned structure.

According to another aspect the invention further includes forming etchant and etching byproduct diffusion pathways within the concentration balancing structures. In one aspect, the diffusion pathways are formed by methods that include a lithographic process, localized illumination, localized electrical currents/electrical fields, localized doping, or a patterned substrate comprising different materials with different hole concentrations.

In another aspect of the invention, the concentration balancing structure is disposed into the substrate at a location that includes a top substrate surface, a bottom substrate surface, or an edge of the substrate surface.

In a further aspect of the invention, the metal pattern and the concentration balancing structures are formed using a process that includes electron beam lithography, ion beam lithography, photolithography, electrodeposition, electroless deposition, sputtering, evaporation, nanoimprint, block copolymer self-assembly, self-assembly of nanoparticles, direct write nanolithography (dip-pen, electropsinning, etc.), printing, deep reactive ion etching, anisotropic wet etch, isotropic wet etch, focused ion beam etching, ion milling, sputter etching, and lift-off.

According to yet another aspect of the invention, the substrate includes a material that includes silicon, GaAs, InP, GaP, GaN, and III-V semiconductors.

### BRIEF DESCRIPTION OF THE DRAWINGS

FIGS. 1a-1b show (1a) schematic drawing of general process flow for metal assisted chemical etching (MACE), (1b) SEM images of zone plate patterns produced using vertical directionality-controlled MACE, according to one embodiment of the current invention.

FIGS. 2a-2c show (2a) SEM image of an isolated array of 125 nm lines and spaces etched using MACE without vertical directionality-control, where splaying is a result of the imbalance in hole concentration; (2b) SEM image of an isolated array of 125 nm lines and spaces etched using MACE with vertical directionality-control, where hole balancing structures are shown to either side of the isolated line array, and lines are etched vertically; (2c) SEM image of 100 nm 1:1 lines, 6.6 μm tall, according to embodiments of the current invention.

FIGS. 3a-3c show (3a) CAD image of metal interconnections and zone plate buttresses in a spiral zone plate dataset. (3b, 3c) Representative SEM images of metalized patterns produced by liftoff showing the metal interconnections as well as the gaps, which are the buttresses of the zone plate, according to embodiments of the invention.

FIGS. 4a-4c show (4a) SEM image of a deeply etched zone plate with a mechanically cleaved portion showing the cross section; (4a) side profile of the lines in cross section, where the thin lines in the center are the zone plate buttresses providing structural stability to the consecutive zones. Metal is seen at the bottom of the zones. Sidewalls are smooth; (4c) cross sectional image of the zones demonstrating very deep, vertical etching, where the inset shows that the line widths are 51 nm at a 1:3 line to space ratio according to one embodiment of the invention.

FIGS. 5a-5c show (5a) SEM image of a cleaved spiral zone plate from a 2×2 array of zone plates, where the cross sectional view shows uniformity in etching depth over a range of feature sizes in the zone plate; (5b) cross sectional views of some of the small zones in this zone plate, where line widths are around 32 nm, 2.5 μm tall, and the period is 136 nm; (5c) a top-down view of the etched zone plate of a charge 20 spiral zone plate.

FIGS. 6a-6b show (6a) schematic of Pt atomic layer deposition of Si zone plate structure, where the starting Si zone plate mold is shown in red, and a 5 nm layer of Al2O3 is deposited followed by a 45 nm layer of Pt, where the coating is conformal over the entire Si zone plate mold; (6b) cross sectional SEM image of a focused ion beam sectioned zone plate, where the image is taken at a tilt angle of 52 degrees.

### DETAILED DESCRIPTION

While diffractive optics have played a major role in nanoscale soft x-ray imaging, they have largely been unavailable for hard x-rays where many scientific, technological, and biomedical applications exist due to the long-standing nanofabrication challenge of creating ultra-high aspect ratio high resolution dense nanostructures. The current invention provides improvements in ultra-high aspect ratio nanofabrication of high resolution, dense silicon nanostructures. In one aspect of the invention, a radically different nanofabrication method is provided, where vertical directionality-controlled metal-assisted chemical etching (V-MACE) is presented. The resulting structures have very smooth sidewalls and can be utilized to pattern arbitrary features, not limited to linear or circular features. According to one embodiment, the application of x-ray zone plate fabrication for high efficiency, high-resolution diffractive optics is provided and the process is demonstrated with linear, circular, and spiral zone plates showing its flexibility. X-ray measurements show high efficiency in the critical outer layers. This method has broad applications such as patterning for thermoelectric materials, battery anodes, and sensors among others.

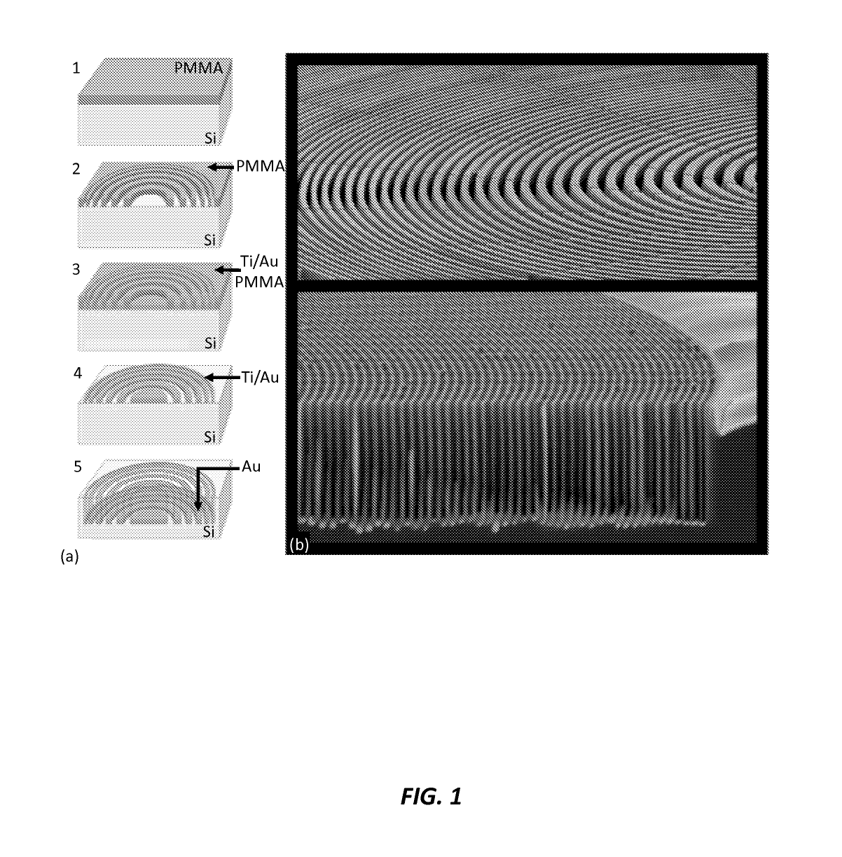

Provided here is a vertical directionality controlled metal-assisted chemical etching process, where the method is capable of providing vertical features in an arbitrary nanoscale pattern with over 100:1 aspect ratio. In one exemplary embodiment, the method is used to create ultra-high aspect ratio x-ray zone plates as shown in FIG. 1b. Vertical directionality controlled metal-assisted chemical etching involves the utilization of additional hole concentration balancing structures, metal anchors internal or external to a desired structure, and appropriate etch chemistry. Advantages of this method include the ability to etch a defined pattern specific to the application of interest including complex, curved, linear, or non-linear patterns. In one aspect, the invention uses a single lithography step combined with a wet etch process. Large diameter optics combined with ultra-high aspect ratio features at high resolution can be achieved, and the structure fabricated using this method is easily compatible with common metallization techniques as well as mechanical stacking methods. In one exemplary embodiment of the invention, platinum atomic layer deposition (ALD) of a Si zone plate mold is described, along with zone plate efficiency measurements using 8.995 keV x-rays, which resulted in a 20.1% first order efficiency with the highest resolution zones.

According to one embodiment of the current invention, during V-MACE, electron holes are constantly generated and injected into silicon. They diffuse into the silicon isotropically and can be modeled as a two-dimensional constant-source diffusion process described by complementary error functions. Therefore, as MACE progresses, the electron holes diffuse to the vicinity of each Au-Si interfaces, eventually, evolving to a profile distribution where the hole-concentration is highest at the center of the Au metal films, gradually decreasing towards the edge. This non-uniform electron hole distribution leads to differences in etch rates throughout a structure and is evidenced in the “outward splaying” effect observed in the deep etch process, preventing the ability to create a vertical etch profile for isolated structures, as seen in FIG. 1a.

This splaying can be corrected using hole concentration balancing structures to create a more uniform hole distribution so as to induce a constant etch rate and thus achieve a vertical etch profile. Balancing structures are any additional structures located in regions where there is a large hole concentration difference. For example, they can be used at the edges of isolated structures, which provide additional holes in the silicon during the MACE and thus balanced concentration in the vicinity of areas where vertical etch directionality is desired. Balancing structures can take the form of a variety of geometries such as a plane catalyst stripe, perforated catalyst stripe, or any other means, not limited to the use of an additional metal catalyst, of creating a balanced hole concentration at the edges, for example using localized electric currents, localized doping differences, or variations of substrate materials for example. In addition, the balancing structure can be induced in any direction to the isolated feature, to the side, above or below, such that the desired hole-concentration balance is obtained within the region of interest, and etch rates in this region become uniform.

According to another aspect the invention further includes forming etchant and etching byproduct diffusion pathways within the concentration balancing structures. In one aspect, the diffusion pathways are formed by porosity control of the metal catalyst or by dimensionality control of the metal catalyst. These can be realized using lithographic or non-lithographic processes.

According to yet another aspect of the invention, the substrate includes a material that includes silicon, GaAs, InP, GaP, GaN, and III-V semiconductors.

In another aspect of the invention, the concentration balancing structure is disposed into the substrate at a location that includes a top substrate surface, a bottom substrate surface, or an edge of the substrate surface.

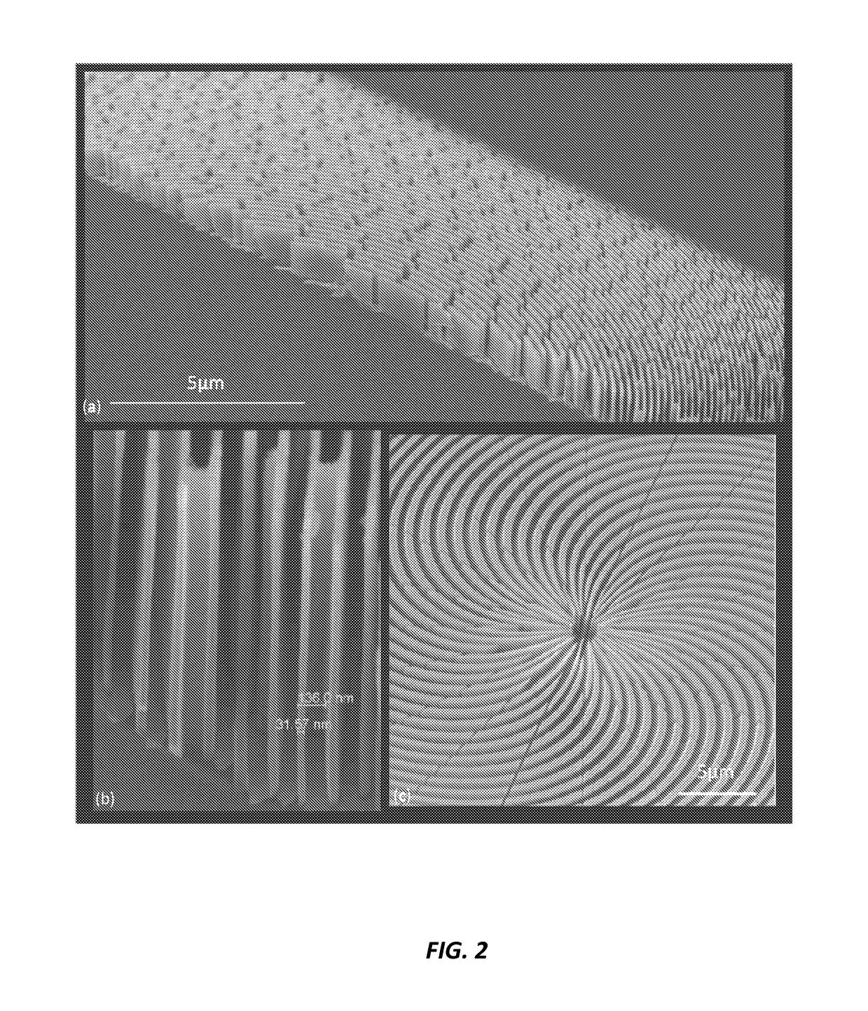

As a demonstration of the effect of hole concentration balancing structures, a high aspect ratio isolated linear grating has been fabricated, with and without the balancing structures, as seen in FIGS. 2a-2c. The linear grating is 10 μm in width with a half period of 125 nm. FIG. 2a shows a cross section of the linear grating without the use of hole-concentration balancing structures. A splaying of the edges of features due to hole-concentration differences leads to non-vertical etching. FIG. 2b shows a cross section of the linear grating with the use of hole concentration balancing structures. The balancing structures in this case are solid stripes of Au catalyst 10 μm in width surrounding the edges of the linear grating. The catalyst dimensions and shape can be tailored to result in minimal disturbance to the final device, or to be used for further processing, for example electroplating. It can be seen that the effects of the hole-concentration balancing structures result in vertical etch control of the linear grating. FIG. 2c demonstrates high aspect ratio fabrication of silicon gratings using this method. The grating in FIG. 2c has a half period of 100 nm and is 6.6 μm tall resulting in an aspect ratio of 66:1.

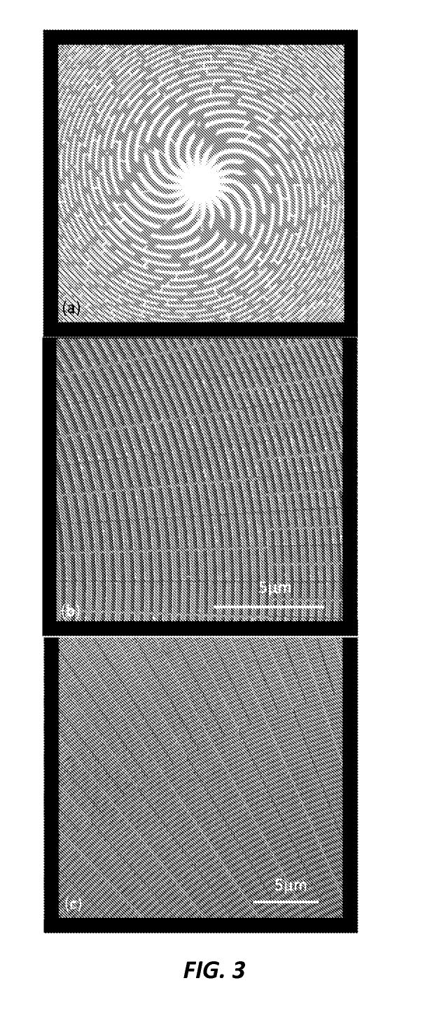

According to one embodiment of the invention, ultra high aspect ratio x-ray zone plates are fabricated using the method according to the invention. In order to obtain additional rigidity in the metal film catalyst to prevent catalyst movements such as folding and sliding, thus minimizing distortion of the metal films during the etching, metal anchors are added to the metal film catalyst. The metal anchors in this case are external to the zones so that each of the zones becomes interconnected. In one aspect the invention further includes forming metal anchors external or internal to the metal patterned structure. This is illustrated in FIG. 3a, variations in the anchoring pattern can result in different mechanical responses of the catalyst during etching. Some variations are shown in the SEM images of zone plate portions in FIG. 3b and FIG. 3c. In addition, to help mitigate the collapse of the zones during, buttressing structures are added, which are discontinuities in the metal catalyst, such that the silicon zones can also be interconnected. This is useful for helping mechanically stabilize the silicon structure during the drying process and during further processing. It is also useful for the creation of a silicon free-standing zone plate or any other interconnected silicon structure.

In a further aspect of the invention, the metal pattern and the concentration balancing structures are formed using a process that includes electron beam lithography, ion beam lithography, photolithography, electrodeposition, electroless deposition, sputtering, evaporation, nanoimprint, block copolymer self-assembly, self-assembly of nanoparticles, direct write nanolithography (dip-pen, electropsinning, etc.), printing, deep reactive ion etching, anisotropic wet etch, isotropic wet etch, focused ion beam etching, ion milling, sputter etching, and lift-off.

Mechanical anchors can be external or internal to the feature. External anchors hold portions of the pattern together, which in this case, are the different zones. Internal anchors are created by holes in the catalyst, which are smaller than the structure that needs to be patterned. They can be utilized both for stability in the metal catalyst film and as a means for etching larger features, giving a physical pathway for etchants to diffuse. The remaining structures left by the internal anchors can be removed through various techniques including silicon oxidation and HF etching.

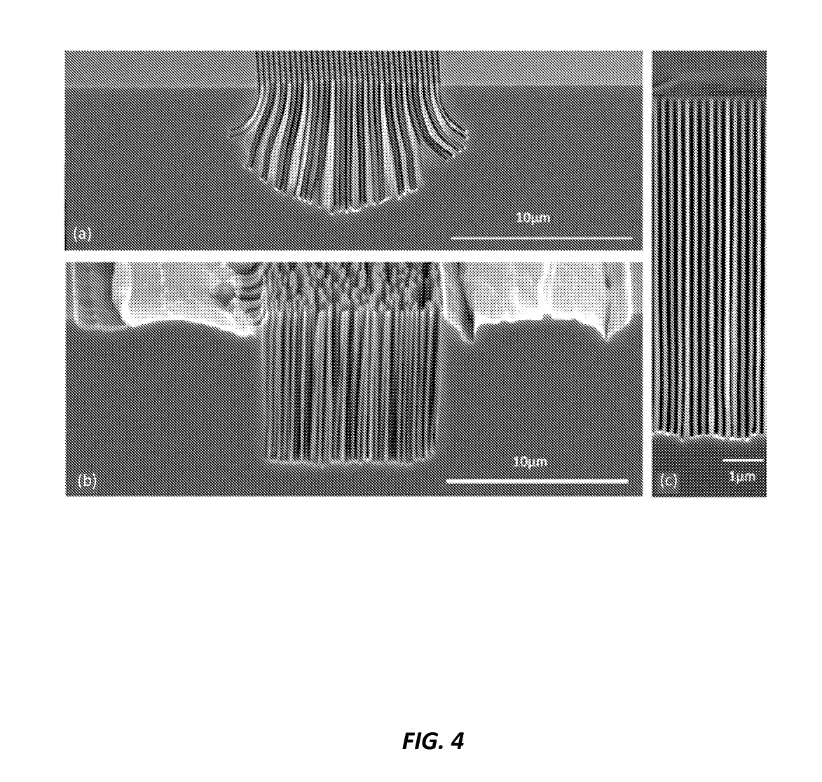

FIG. 4a illustrates the fabrication of a very high aspect ratio zone plate in silicon with a diameter of 100 μm, outermost zone width of 100 nm, and a duty cycle of 1:3. The duty cycle was designed such that atomic layer deposition can be performed later for zone doubling or so that the zone plate can be utilized for higher order diffraction. The zone plate was mechanically cleaved to examine the cross section. FIG. 4b shows the sidewalls of this cross section. The sidewalls after this etch are quite smooth and determined by the roughness in the metal catalyst. The thin vertical line, 30 nm in width, shown at the center of the tilted zone segment is a silicon buttresses that connects the neighboring zones. They can also be seen in FIG. 4a. The cross section clearly demonstrates that high aspect ratio features with a vertical profile has been achieved. Shown in FIG. 4c are lines that have 100 nm half period and are 14 μm tall. However, porous silicon formation can be seen at the top of the structures along with some curvature. These can easily be removed with a silicon etch. The vertical portion of the features remains at over 12 μm tall, leading to an aspect ratio greater than 120:1. The inset in FIG. 4c shows a zoomed in version of the lines, and control of the silicon lines, at 51 nm width.

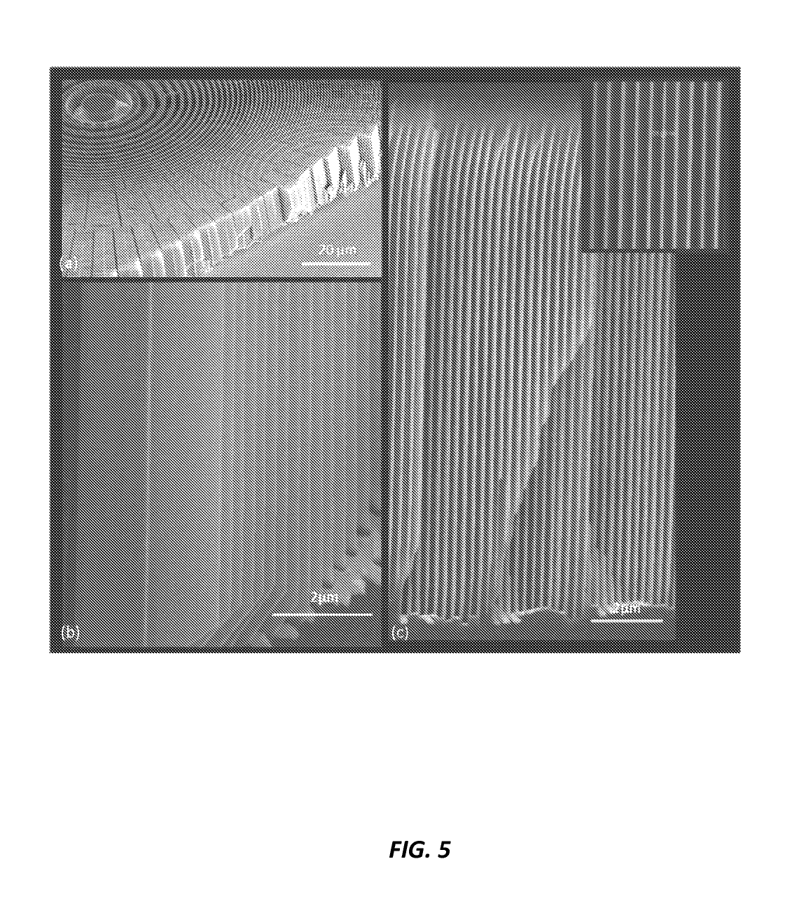

Spiral zone plates are used to generate x-rays with orbital angular momentum. According to one exemplary embodiment, 2×2 array of spiral zone plates, each with a square aperture, diameter of 60 μm, smallest outermost zone width of 60 nm, duty cycle of 1:3, and spiral charge of 20 were fabricated. In this case, the adjacent zone plates in the array served as the hole balancing structures. FIG. 5a shows a SEM image of a cross section of this zone plate when mechanically cleaved. Uniformity in the etch depth across the range of feature sizes in the zone plate can be seen. FIG. 5b shows zones close to the edge of the zone plate with 32 nm line width and 136 nm period, demonstrating a duty cycle of 1:3. The zones here are 2.5 μm tall creating aspect ratios of around 40:1. FIG. 5c shows a top-down view of the etched zone plate of a charge 20 spiral zone plate.

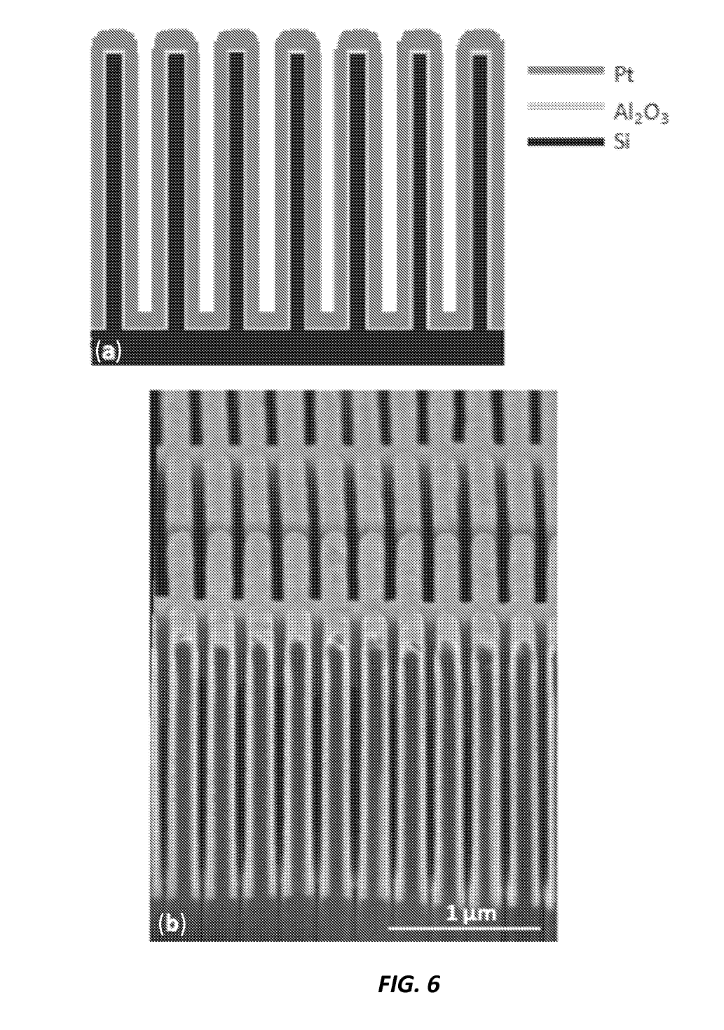

For use with hard x-rays, a silicon zone plate mold must be metalized, for example, through atomic layer deposition or electroplating. Electroplating provides high efficiency throughout an entire zone plate area while traditional atomic layer deposition provides the ability to create higher resolution zones with high efficiency, but in a tradeoff of overall zone plate efficiency. A combination of both methods, or variations of these methods, can be envisioned for achieving the benefits of both techniques. In one exemplary experiment, Pt atomic layer deposition was performed, and efficiency of the outermost zones was measured at 8.995 keV using the beamline 6.2 transmission x-ray microscope at the Stanford Synchrotron Radiation Laboratory. A silicon zone plate mold was fabricated using vertical directionality controlled MACE. A 5 nm layer of Al₂O₃ followed by a 45 nm layer of Pt were deposited as depicted in FIG. 6a. The final platinum zone plate structure had a 50 nm outermost zone width, 200 μm diameter, and 2.1 μm zone thickness. An SEM image of the resulting structure is shown in FIG. 6b. Local zone plate efficiency measurements over a 30 um diameter outermost zone region resulted in a 20.1% first order diffraction efficiency. Note, this zone thickness will yield higher efficiencies at energies greater than 10 keV due to more favorable phase shifting properties of the Pt zones at higher energies.

Turning now to the lithographic process for linear gratings, according to the current invention. In one exemplary embodiment, a 60 nm thick layer of 950K PMMA is spin coated onto a P-type, Boron doped <100> CZ Prime silicon wafer with 10-20 Ω-cm resistivity (SiliconQuest). The resist layer is then baked at 170° C. for 30 minutes and patterned with a 100 keV JEOL 6300 electron beam lithography system. The patterned resist was then developed in 1:3 MIBK:IPA at 4° C. for 30 seconds. An oxygen descum etch was performed to remove any residual PMMA. The metal catalyst layer, which includes 2 nm Ti and 15 nm Au is then electron beam evaporated onto the pattern. Liftoff was performed in acetone. The patterned piece and etching solution including 5.3 M HF, 0.25 M H₂O₂, and 50 M H₂O are cooled to 10° C., and a droplet of etchant is placed on top of the pattern. Etching was performed at 10° C. for 40 minutes and then quenched with a water rinse. The pattern was dried using nitrogen.

Regarding the lithographic process for high aspect ratio zone plates, a 300 nm thick layer of ZEP520A is spin coated on a P-type, <100> FZ Prime silicon wafer with >10,000 Ω-cm resistivity (SiliconQuest). The resist was patterned with a 100 keV JEOL 6300 electron beam lithography system. The patterned resist was then developed in Xylenes at 20° C. for 40 seconds. An oxygen descum etch was performed to remove any residual ZEP520A. The metal catalyst layer, 2 nm Ti and 75 nm Au, was then electron beam evaporated onto the pattern. Liftoff was performed in Remover PG (MicroChem) at 70° C. The patterned piece and etching solution includes 5.3 M HF, 0.25 M H₂O₂, and 50 M H₂O were cooled to 6° C. using a cold plate, and a droplet of etchant was placed on top of the pattern. Etching was performed at 6° C. for 90 minutes and then quenched with a water rinse. Water was replaced with isopropyl alcohol, and the sample was dried using a critical point dryer (Tousimis).

Turning now to the lithographic process for high resolution zone plates, a 60 nm thick layer of 950K PMMA is spin coated onto a P-type, Boron doped <100> CZ Prime silicon wafer with 10-20 Ω-cm resistivity (SiliconQuest). The resist layer is then baked at 170° C. for 30 minutes and patterned with a 100 keV JEOL 6300 electron beam lithography system. The patterned resist was then developed in 1:3 MIBK:IPA at 4° C. for 30 seconds. An oxygen descum etch was performed to remove any residual PMMA. The metal catalyst layer, which includes 2 nm Ti and 15 nm Au is then electron beam evaporated onto the pattern. Liftoff was performed in acetone. The patterned piece and etching solution comprised of 5.3 M HF, 0.25 M H₂O₂, and 50 M H₂O are cooled to 10° C., and a droplet of etchant is placed on top of the pattern. Etching was performed at 10° C. for 30 minutes and then quenched with a water rinse. The pattern was dried using nitrogen.

Regarding the Pt metallization and zone plate efficiency measurement process, a Si zone plate mold was fabricated using vertical directionality controlled MACE. A 5 nm layer of Al₂O₃ followed by a 45 nm Pt layer was deposited onto the zone plate mold, resulting in a zone plate with 50 nm outermost zone width, 200 μm diameter, and 2.1 μm zone thickness. The zone plate was then placed in the transmission x-ray microscope at beamline 6.2 at the Stanford Synchrotron Radiation Laboratory for zone plate efficiency measurements. The energy used for the measurement was 8.995 keV. A 30 μm pinhole diameter was placed behind a portion of the capillary condenser optic of the microscope to restrict the illumination area of the zone plate. In order to obtain the reference intensity, the zone plate was moved out of the way, while the radiation still passed through the pinhole and substrate. The intensity of the spot at the CCD was integrated. To obtain the diffracted efficiencies, the zone plate was then placed behind the same illumination area, and the diffracted spots were observed at the CCD. The total radiation of the first order diffracted spot was integrated, and the first order diffraction efficiency was calculated by taking the ratio of the radiation in the first order diffraction spot with the radiation in the reference spot.

The current invention provides ultra high aspect ratio etched silicon zone plate molds fabricating using vertical directionality-controlled metal assisted chemical etching. Because a zone plate has a large range of feature sizes, larger in the center, and smaller in the outermost zones, etch rate variations as a function of zone width need to be controlled for uniform, vertical etching. These aspects are minimized by utilizing relatively low temperature and low hydrogen peroxide concentrations, along with appropriate dimensional variations in the pattern, such as catalyst interconnection density and Si zone buttress density. The relatively low temperature and low hydrogen peroxide concentration causes the reduction reaction of hydrogen peroxide to become the rate-limiting step in MACE such that the etch rate variation, originally due to different etchant diffusion lengths of different feature sizes, is minimized.

This etching method of the current invention is compatible with other catalyst patterning schemes. According to one embodiment, a liftoff process is used to pattern the metal catalyst, but other embodiments can be used for patterning including, but not limited to, focused ion beam and reactive ion etching of the metal catalyst. It is important in all cases that the interface between the silicon and the metal catalyst be clean for directional control during the etching.

According to one exemplary embodiment, Au catalysts are used, and a thin Ti layer was utilized as an adhesion layer for the liftoff process that is later dissolved in the etchant solution. According to further embodiments, other metal catalysts, such as Ag and Pt, and other substrates such as GaAs can be etched using this method. Therefore, this current invention is not limited only to the specific catalyst material and substrate materials described in the example experiments presented here.

This fabrication method of the current invention is suitable for creating optics optimized for the EUV to the hard x-ray regime. For the hard x-ray regime, the zone plates can be combined with metallization techniques. Because the metal catalyst sinks to the bottom of the trench after etching, electroplating can be performed for metallization such that a gold zone plate can be made. In addition, atomic layer deposition for coating a variety of different types of materials, optimized for particular wavelengths, can also be performed. For example, Au zone plates with 6 μm thickness will produce around 35% first order diffraction efficiency at 25 keV photon energy. Au zone plates with 10 μm thickness will produce close to 40% first order diffraction efficiency at 50 keV, the maximum efficiency for a binary phase zone plate. In addition, combining two zone plates with different patterns such that a blazed zone plate profile is created through mechanical stacking, could further increase the efficiency.

For EUV and soft x-rays, etching does not necessarily have to be very deep. As it is currently possible to create nanowires <10 nm wide using conventional MACE, allows one to etch similar dimensions for x-ray optics applications through application of vertical directionality-controlled MACE. In addition, it is also possible to directly use the silicon lens and forgo the metallization or material deposition process for softer x-ray energies. For example, with 50 eV radiation, a silicon zone plate with 280 nm thickness will produce a theoretical first order efficiency of around 27%. For 700-900 eV wavelength, in the soft x-ray region, a silicon zone plate of 1 μm thickness will produce a theoretical first order efficiency of around 26-29%. In each of these cases there will be some area loss, resulting in slight lowering of the theoretical efficiency due to the Si buttress and catalyst anchor density, but overall efficiencies will remain high compared to what is currently available. In addition, as in the case of hard x-rays, these zone plates can be combined with existing concepts such as stacking to produce shaped, blazed zones, thicker, or interleaved structures for increased efficiency. For applications requiring free-standing zone plates, especially important at the low EUV energies, this fabrication process can be performed on commercially available single crystalline Si membranes.

A process to fabricate ultra-high aspect ratio, dense features in a complex, non-repetitive nanostructure using vertical directionality-controlled MACE, with optimizations of metal catalyst mechanical anchors, hole concentration balancing structures, low temperature etching, and low hydrogen peroxide concentration for the case of x-ray zone plate optics fabrication has been demonstrated. This leads to the capability to create high efficiency zone plate optics and more general x-ray diffractive optical structures such as coded apertures and collimators for hard x-rays, far beyond what is currently available. The versatility of this ultra-high aspect ratio etching process for nanostructures can also lead to its utilization for a broad array of applications including sensors, and energy-related nanostructured materials, among others.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. A method of ultra-high aspect ratio high resolution vertical directionality controlled metal-assisted chemical etching, V-MACE, comprising:
a. forming a metal pattern on a substrate surface;
b. forming hole concentration balancing structures onto said substrate, wherein said hole concentration balancing structures are proximal to said pattern;
c. etching directionality controlled features from said substrate surface into said substrate, using metal-assisted chemical etching, MACE, wherein the direction of said features are controlled by said hole concentration balancing structures.

2. The method according to claim 1 further comprises forming metal anchors external or internal to said metal pattern.

3. The method according to claim 1 further comprises forming etchant and etching byproduct diffusion pathways within said metal pattern.

4. The method according to claim 3, wherein said diffusion pathways are formed by porosity control in a patterned metal catalyst or dimensionality control of said patterned metal catalyst, wherein said porosity control in said patterned metal catalyst or dimensionality control of said patterned metal catalyst comprises using a process selected from the group consisting of electron beam lithography, ion beam lithography, photolithography, electrodeposition, electroless deposition, sputtering, evaporation, nanoimprint, block copolymer self-assembly, self-assembly of nanoparticles, direct write nanolithography, printing, deep reactive ion etching, anisotropic wet etch, isotropic wet etch, focused ion beam etching, ion milling, and sputter etching.

5. The method according to claim 1, wherein said hole concentration balancing structure is disposed into said substrate at a location selected from the group consisting of a top substrate surface, a bottom substrate surface, and an edge of said substrate surface.

6. The method according to claim 1, wherein said metal pattern and said hole concentration balancing structures are formed using a process selected from the group consisting of electron beam lithography, ion beam lithography, photolithography, electrodeposition, electroless deposition, sputtering, evaporation, nanoimprint, block copolymer self-assembly, self-assembly of nanoparticles, direct write nanolithography, printing, deep reactive ion etching, anisotropic wet etch, isotropic wet etch, focused ion beam etching, ion milling, sputter etching, localized illumination, localized electrical currents/electrical fields, localized doping, and a patterned substrate comprising different materials with different hole concentrations.

7. The method according to claim 1, wherein said substrate comprises a material selected from the group consisting of silicon, GaAs, InP, GaP, GaN, and III-V semiconductors.
